(19) United States
(12) Patent Application Publication
(10) Pub. No.: US 2013/0344195 A1
(43) Pub. Date: Dec. 26, 2013

(54) Stable and bioavailable lycopene formulations and associate methods

(71) Applicant: Le Thuy Vuong, Peteluma, CA (US)

(72) Inventor: Le Thuy Vuong, Peteluma, CA (US)

(21) Appl. No.: 13/897,279

(22) Filed: May 17, 2013

(30) Foreign Application Priority Data
May 17, 2012 (US) 13897279

(51) Int. Cl. A23L 1/30

(52) U.S. Cl. CPC A23L 1/3002
USPC 426/2; 426/384; 426/541; 426/648; 426/583; 426/601; 426/250

(57) ABSTRACT

Stable and bioavailable formulations and methods for lycopene extraction are disclosed and described. In particular, methods to extract plant lycopene without the use of organic (chemical) solvents, to produce a water soluble food ingredient and colorantant, which are stabilized by natural, antioxidants (vit E, vit C, beta-carotene). In some aspects, the formulation can include concentrate, or dry powder of the aril of momordica conchinchinensis spreng (gac), in combination of at least one other antioxidant. Formulations described herein are palatable and less acidy than, tomatoes' products. The methods do not involve use of chemical solvents, no alcohol, therefore is safe for consumption, and produces no toxic residue, nor toxic waste. This invention provides stable and bioavailable lycopene to populations whose intake of lycopene is low, or for those who have problems with high acid foods, and can be used, in beverage, food, supplements, cosmeticals and nutraceuticals.

### CROSS REFERENCE TO RELATED APPLICATION

This application is a continuation-in-part of U.S. Pat. No. 6,770,585 (application Ser. No. 10/211,814 filed Aug. 5, 2002) and of U.S. patent application Ser. No. 10/163,280 filed on Jun. 6, 2002, now abandoned, which claims the benefit of U.S. Provisional Patent Application Ser. No. 61/688,596 filed on May 18, 2012 both of which are incorporated herein, by reference,

### FIELD OF INVENTION

The present invention relates to beverage, food, fruit drinks, fruit concentrates, and nutritional drinks. More particularly, the invention relates to methods and formulation, containing lycopene from fruit. Accordingly, the invention involves the fields of botany, nutritional and health sciences, nutraceutical, cosmeceuticals, natural ingredients, and medicine.

### BRIEF SUMMARY OF THE INVENTION

Stable and bioavailable formulations and methods for lycopene extraction are disclosed and described. In particular, methods to extract plant lycopene without the use of organic (chemical) solvents, to produce, a water soluble food ingredient and colorantant, which are stabilized by natural, antioxidants (vit E, vit C), and beta-carotene, in some aspects, the formulation can include concentrate, or dry powder of the aril of momordica conchinchinensis spreng (gac), in combination of at least one other antioxidant. Formulations described herein are palatable and less acidy than tomatoes' products. The methods do not involve use of chemical solvents, no alcohol, therefore is safe for consumption, and produces no toxic residue, nor toxic waste. This invention provides stable and bioavailable lycopene to populations whose intake of lycopene is low, or for those who have problems with high acid foods, and can be used in beverage, food, supplements, cosmeticals and nutraceuticals.

### OBJECTS AND ADVANTAGES

The objects of this invention describes methods and formulations containing, stable and bioavailable lycopene from Momordica cochinchinensis Spreng (gac, spiny melon). The formulations contain no chemical solvents, and is thus safe for human and animal consumption.

The formulations can be applied to beverage, food, pharmaceuticals, and cosmetics industries as well as providing a suitable, effective food additive and colorant.

Gac or spiny melon is a variety of melon often seen in Southeast Asia, Seed pulp of spiny melon contains high amounts of carotenoids. The dry pulp, which is a residue of oil extraction, is usually discarded. In one of the embodiments of this invention, the seed pulp after dried and oil is removed is further processed to produce a composition high in lycopene. There is no organic solvent used in this process and thus the product is safe for human and animal consumption. Another advantage of this invention is that the process used to obtain lycopene is simple and can be applied in rural areas. Lycopene is among hydrocarbon carotenoids with antioxidative activities. Extraction methods and formulations not only contain high concentration of lycopene, also vitamin E, and 8% fatty acids making lycopene highly bioavailable. Formulations also contain beta-carotene. According to epidemiological and animal studies, these carotenoids play an important role in the prevention of cancer, cataracts, and degenerative diseases such as heart disease.

### DEFINITION OF TERMS

In describing and claiming the present invention, the following terminology will be used.

The singular forms “a,” “an,” and “the” include plural referents unless the context clearly dictates otherwise. Thus, for example, reference to “a carrier” includes reference to one or more of such carriers, and reference to “an excipient” includes reference to one or more of such excipients.

As used herein, “formulation” and “composition” may be used interchangeably herein, and refer to a combination of two or more elements, or substances. In some embodiments a composition may include an active agent and a carrier.

As used herein, “effective amount” or “antioxidant absorption enhancing amount” refers to an amount of an ingredient, namely composition, is sufficient to achieve an intended compositional or physiological effect. Thus, a “therapeutically effective amount” refers to a non-toxic, but sufficient amount of an agent, including active agents, to achieve therapeutic results in preventing or ameliorating a condition for which the active agent is known to be effective, or in attaining a desired physiologic effect. It is understood that various biological factors may affect the ability of a substance to perform its intended, task. Therefore, an “effective amount,” “antioxidant absorption enhancing amount,” or a “therapeutically effective amount” may be dependent in some instances on such biological factors. Further, while the achievement of therapeutic effects may be measured by a physician or other qualified medical personnel using evaluations known in the art, it is recognized that individual variation and response to treatments may make the achievement of therapeutic effects a subjective decision. The determination of an effective amount is well within the ordinary skill in the art of pharmaceutical sciences and medicine. See, for example, Meiner and Tonascia, “Clinical Trials: Design, Conduct, and Analysis,” Monographs in Epidemiology and Biostatistics, Vol. 8 (1986), incorporated herein by reference.

As used herein, “carrier” or “inert carrier” refers to a substance with which a bioactive agent or a nutritional agent may be combined to achieve a specific dosage formulation for delivery to a subject. As a general principle, carriers must not react with the bioactive. agent in a manner which substantially degrades or otherwise adversely affects the bioactive agent or its potency.

As used herein, “excipient” refers to substantially inert substance which may be combined with an active agent and a carrier to achieve a specific dosage formulation for delivery to a subject, or to provide a dosage form with specific performance properties. For example, excipients may include but are not limited to binders, lubricants, etc., but specifically exclude active agents and carriers.

As used herein, “subject” refers to a mammal that may benefit from the administration of a composition or method as recited herein. In this document, the subject will be a human.

As used herein, “administration,” and “administering” refer to the manner in which an active agent, or composition containing such, is presented to a subject. Administration can be accomplished by various routes well-known in the art including topical or oral methods.

As used herein, “coadministration” refers to administration of two or more active agents in a manner that will allow them to be present together in-vivo for period of time. Accordingly, while the term “coadministration” includes simultaneous administration of two or more active agents, and administration from a single formulation, it is to be understood that it is not limited thereto.

“Oral administration” can be achieved by swallowing, chewing, or sucking of an oral dosage form comprising the drug. Examples of well known oral dosage forms include tablets, capsules, caplets, powders, granulates, beverages, syrups, elixirs, confections, or other food items, etc.

As used herein, “extract” when used in connection with a plant, tree, herb, fungus, etc., refers to material which has been removed from the source, or a portion thereof, including the flower, fruit, seed, peel, leaf root, bark, stem, etc. As will be recognized by those of ordinary skill in the art, extracts may be either crude or refined to a selected degree in order to isolate specified materials or active agents. Extracts can take a variety of forms including powders, juices, purees, etc. A number of extraction processes that can be employed to produce the compositions of various types will be recognized by those skilled in the art, such as dehydration, lyophilization, etc.

“Synergistic”, “synergism”, “synergistically effective” or “synergistically enhances”, may be used interchangeably and refer to a situation in which the combined effect of two agents is greater than which would be predicted from their individual effects. Various mechanisms for calculating or otherwise determining synergism are known to those of ordinary skill in the art.

“Antioxidant” refers to a chemical compound, an enzyme or other organic molecule which prevents free radicals from causing oxidation of molecules in the body. Susceptible molecules include without limitation, such vital entities as DNA, RNA, lipids (fats), and proteins. The antioxidant, by reacting with the oxidant, protects these important molecules from being damaged. Examples of antioxidants include without limitation, vitamins A, C, E, carotenoids, polyphenols, and certain minerals.

The term “Gac”, “redmelon™”, “gac fruit” refer to the plant Momordica cochinchinensis Spreng, or of plants significantly related thereto, grown anywhere in the world including blends, mixtures, and combinations of such strains and relatives.

The term mc extract, mc powder, or mc lycopene, or mc lycopene extract refer to a product rich in bioavailable lycopene from Momordica cochinchinenisis Spreng. produced from the process described herein. The extract includes dried powder, concentrate, puree, or oil extract from Momordica cochinchmensis.

As used herein, the terms “bioavailable” or “bioavailability” when used in connection with antioxidants refer to the antioxidant portion of a formulation which is available to be absorbed or taken up by the subject.

As used herein the term “stability” when used in connection with carotenoids refer to the portion of the carotenoids in the formulations that is not destroyed or oxidized or isomerized and available for the uptake by a subject.

As used herein, a plurality of items, structural elements, compositional, elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, solubilities, and other numerical data may be presented herein in a range format. If is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited.

For example, a concentration range of 0.5 to 400 should be interpreted to include not only the explicitly recited concentration limits of 0.5 and 400, but also to include individual concentrations within that, range, such as 0.5, 0.7, 1.0, 5.2, 8.4, 11.6, 14.2, 100, 200, 300, and sub-ranges such as 0.5-2.5, 4.8-7.2, 6-14.9, 55, 85, 100-200, 117,175, 200-300, 225, 250, breadth of the range or the characteristic being described.

### BACKGROUND OF THE INVENTION

Lycopene is the major carotenoid in human plasma, tissue and diet and exhibits the highest antioxidant activity and singlet oxygen quenching ability of all dietary carotenoids (Mascia et ai.). According to epidemiological and animal studies, Lycopene plays an important role in the prevention of cancer, cataracts, and degenerative diseases such as heart disease (Bendich, Giovannucci et ai., Levy et ai., Narisawa et ai.).

Humans can not make lycopene but obtain lycopene from diet, and the richest source of lycopene in western diet are tomatoes and tomato products (Gartner et ai., Khachik, Sadler et ai. Tan).

Lycopene in large quantities for commercial use requires extensive production of tomatoes, which necessitates availability of land, full sun, and water.

Lycopene extract methods from tomatoes are mainly achieved by chemical solvents, methanol, hexane, ethyl acetate, dichlorobis methane, acetone, diethyl ether, n-hexane, ethyl acetate. Those chemicals are not sate for human or animal consumption, nor for the environment.

Steam distillation, or supercritical fluid CO2 extraction methods have been published but only in laboratory settings (Ollanketo eta al., Rozzi et al.). This technique is safe and ecologically friendly, however, costly, and so far, has not been carried out in commercial quantity.

Tomato products contain high acid levels, and thus are not desirable for some populations. Other fruits also provide lycopene, however in small amounts, such as watermelon, persimmon, papaya, guava, pitanga, rosehip. Efficient methods for commercial production of lycopene from those sources involve the use of chemical solvents, the products are not deemed food grade and should not be used in food or supplements for human or animal consumption. Further, the method can not be applied in regions of the world where chemicals or high technological instruments are not available. Bioavailability is the amount of bioactive components in diet that is available to the target tissues. Bioavailability of lycopene depends on many factors: concentration in the food, the food matrix (oil based is more bioavailable, fibrous or water based is not as bioavailable), type of food, the presence of other nutrients (vitamin E, vitamin C have been shown to be enhancing); type of delivery or packaging since lycopene can be destroyed or reduced its bioactivity by exposed to air, high heat, cooking technique (high heat isomerizes lycopene, reducing its bioavailability). The present of fatty acids is important in the absorption and deliver of lycopene to target tissue (Erdman), and medium chain fatty acids and unsaturated can improve absorption (Conlon L E, King R D, Moran N E, Erdman J W Jr) Lycopene in fruits has been shown to be more bioavailable than lycopene in vegetables (Suskia de Pee). Another factor that involves in the taste of the dietary source of lycopene is acid level. Tomatoes are generally considered a high acid food item with a pH below 4.6. Unfortunately, a lot of misinformation has been printed in the popular press about “low acid” tomatoes referring to those with a sweet, non-tart taste. These tomatoes are often white, yellow, or pink in color, low in lycopene but are not low in acid content. High acid level in tomatoes makes this source less attractive for applications in beverage and for target populations who can not tolerate high acid food.

Lycopene is unstable when exposed to light, heat and oxygen. Exposure to light and heat triggers isomerization from the trans to cis configurations. The cis-isomers of lycopene have lower absorption, and thus not bio-available as compared to the trans configurations.

Momordica cochinchinensis Spreng (spiny melon, gac, redmelon) is indigenous to Southeast Asia and Australia. Descriptions of the plant can be found in several publications (Bailey, Heiser, Herklots and Perry). Medicinal use of Momordica cochinchinensis seeds and seed pulp, and other parts of the plant was described by Nguyen, and by Vuong (1998).

Concentrations of total carotenoids in Momordica cochinchinensis (17000 to 75000 mcg/100 g wet weight) can be found in a publication by West & Poortvlict. Lycopene is the main carotenoid in the fruit (8000 ppm, or 80% to 92% of total carotenoids and beta-carotene is another major carotenoid (4-6% of total carotenoids). A publication by Vuong described the plant and discussed its use in improving lycopene status of children in Vietnam (2000). Another publication by Vuong et al described a supplementation trial office mixed with Momordica cochinchinensis pulp to improve plasma retinol and beta-carotene of preschoolers in Vietnam (Vuong et ai., 2002).

Method to extract oil from momordica cochinchinensis spreng using cold press has been provided in U.S. Pat. No. 6,770,585. Another method which uses chemical solvent to extract carotenoids from “gac” was published in U.S. Pat. No. 7,572,468. As described in this method, the extraction solvent comprises a blend of ethyl lactate and ethanol. This method of extraction of carotenoids from momordica cochinchinensis used chemical solvents and therefore products are not deemed to be safe for consumption.

Smidt et al., described nutritional formulations of “gac” extract and other plant extract to enhance absorption of antioxidants. Mower et al. described the use of momordica cochinchinensis puree as a sweetener, to mask the bitterness of other phytonutrients in the composition. Chang, Teh Shan described the use of momordica cochinchinensis as one of the components in a paste that is useful for re-establishing of vital energy, invigorating of blood circulation. Other foreign patents on the use of momordica cochinchinensis described the use of components inside the seed of the fruit in the treatment of skin disorders.

Dylan, et al in EU Patent CN101611878 (A) described method for preparing carotenoids in “gac” fruit using alcohol. Although the invention appeared to use no toxic chemicals, the method described the use of alcohol, or anhydrous sodium sulfate, or ethyl acetate. This method also described the “gac” fruit as a “wood turtle fruit”, which did not correctly describe the fruit Momordica cochinchinensis Spreng.

In view of the foregoing, methods and formulations which can deliver safe (no chemical solvents), stable and bio-available lycopene in a low acid formulations, that can impart positive health benefits to humans and animals will be discussed.

### DETAILED DESCRIPTION OP THE INVENTION

The novelty of the invention is in the use of the seed pulp of Momordica cochinchinensis to obtain lycopene. Lycopene obtained this way is stable since it is contained in a lipid matrix high in alpha-tocopherol and other antioxidants, and bioavailable. Further, the methods described do not involve chemical solvents, and therefore the products are safe for human and animal consumption, without any toxic residue, nor toxic waste.

Momordica Cochinchinensis Spreng (spiny melon) is botanically classified as Family Cucurbitaceae, Genus Momordica, Species Cochinchinensis. This plant is indigenous to Southeast Asia and Australia but can be cultivated in any regions of the world.

Momordica cochinchinensis seed pulp can be obtained from fresh fruits or frozen. If obtained from fresh fruit, the fruits selected should be ripen, meaning when the exocarp is 90% orange, and should not show any evidence of infested or rotten. Fruits were washed and opened.

Seeds can be removed manually or by a de-seeding machine. If removed manually, seed pulp may be dried slightly in low heat. Water content of the seed pulp is about 78%, concentration of lycopene is 408 ppm, compared to tomatoes (25 ppm).

The next step is to reduce water to about 5 ww %. This can be done either in a box dryer, by centrifuging at temperatures between 60 to 70 degree C. and centrifugal force between 2600 and 4000 G. The dried membrane can be pulverized further either manually or mechanically to produce powder (LI), with lycopene concentrations between 30000-50000 ppm. Fatty acids are from 5-7 ww %.

In another embodiment, wet pulp is dried in an electric powered drying box under 60° C. The dried momordica cochinchinensis pulp preferably has a moisture content in the range of 10-15% by weight. Dried pulp may be heated slightly before pressing for oil using an oil expeller. Oil extract, OI, of Momordica cochinchinensis pulp contains from 3000 to 6500 ppm of carotenoids by weight, and 500-600 ppm of lycopene, 130 ppm vitamin E at pH. This source of lycopene is stable and highly bioavailable. Bioavailability studies using in-vitro digestion/caco cell techniques also showed a high bioavailability for these carotenoids. Tins is in sharp contrast to other carotenoid rich fruits, which show a relatively low carotenoid bioavailability due to the lack of uptake enhancing lipids.

Dried-deoiled pulp contains 17-20% water is dried further in low heat, to reduce water, and pulverized to produce lycopene powder (DOI) which has a moisture content in the range from 0.1% to 10% by weight, and 4500 ppm of lycopene, 1500 ppm beta-carotene, 100 mcg/g of vitamin E. This method can be applied in rural setting without use of food processing equipments. In one embodiment, dried-deoiled seed pulp is mix with coconut oil, which is wildly available, to produce a formula rich in vitamin E, and lycopene.

The dried pulp may be further processed by drying, pulverizing, and purifying. The methods of drying consist of but are not limited to freeze drying (lyophilizing), drum drying, tray drying, sun drying, and spray drying. Further extraction of lycopene can be done using supercritical fluid extraction, until water content was between 0.01.-0.1%. The lyophilized (freeze dried) membrane has mildly sweet taste and can be easily mixed in beverage or food stuff. Purification of lycopene can be done by recrystalization. The preferable process to totally utilize the nutrients in the pulp including fiber and maximize bioavailability of carotenoids (lycopene, betacarotene) is to reduce particle size by any commercial grinding or pulverizing to product a product (El) in powder form with lycopene concentrations between 30000-50000 ppm, and fatty acids are from 5-7 ww %. The powder then can be packaged in air-tight, light proof containers for storage, transport and/or further processing. This lycopene rich formulation can be used in a variety of applications, including, but not limited to cosmetics, nutritional products, dietary supplements, as a product itself such as snack food, or flavoring, or in animal feedstuffs.

Mc lycopene extract can be re-dispersed in an aqueous solution, or lipid based food stuff or complex carbohydrate, or protein rich food stuff to enhance bioavailability.

A stable and bioavailable food colorant composition containing mc oil extract provides 1800 ppm. lycopene 52 I.U./100 g vitamin E.

A primary composition that includes at least one of the above compositions (LI, OI, DOI, or EI) and grain starch such as rice powder, or rice milk in an amount effective to increase bioavailability of the lipophilic bioactive compound, namely lycopene and beta-carotene.

The following tables demonstrate nutritional values of the embodiment. Values presented are representative of quantitative analyses for this invention, but not inclusive or absolute, since nutrient contents of fruits may vary depending on ripeness, growing regions or climate and post-harvest handling and processing,

| | Per 100 grams |
|---|---|
| Protein | 12.54 |
| Fat | 6.54 |
| CHO | 58.31 |
| Dietary Fiber | 22.71 |
| Vitamin E | 5.02 |
| Lycopene | 4 g |
| Beta-carotene | 1.5 g |
| Micronutrients | |
| folate (mcg) | 4.5 |
| calcium | 27 g |
| Zinc | 0.69 |
| B6 | 0.14 |
| niacin | 2.2 |

Compositions above (LI, DOI and EI) can be mixed with a solution of polysaccharide and lipid composition, or disperse in an aqueous medium to enhance stabilization of lycopene. In one embodiment, the composition EI is mixed with whey protein to enhance dispersing capability and stability. Bioavailability of mc lycopene extract has been shown to be enhanced when taken with diet high in starch, protein or fat. In one particular embodiment the mc lycopene extract is homogenized with plain yogurt. In another embodiment, mc lycopene extract is homogenized with coconut water. Stability of mc lycopene in both solutions is enhanced in that it does not required to be in ligh-prevented inert environment, and the red color which indicative for the lycopene remains after 2 months in refrigerator in scaled container.

In another embodiment, mc extract is hydrated with coconut cream. The solution is mixed with cooked rice (5% mc lycopene extract). Bioavailability of lycopene in subjects measured by plasma response was enhanced 10-fold compared to the same intake of synthetic powder and in a supplement form.

In one embodiments mc extract is stabilized with antioxidants from fruit extract such as lichi, passion fruit, orange juice.

In another embodiment, the composition LI is disperse in an aqueous medium, preferable coconut water to provide formulations with enhance bioavailability and stability of the powder formulation.

In one preferred embodiment, mc powder is mixed with 100 g rice starch, which added 50 mg of complex carbohydrate (CHO) and 4 mg of protein, 340 mg vitamin E. Increase in bioavailability of lycopene in subjects receiving the formula with CHO by plasma response was shown. This composition contains 5000 ppm of lycopene, 2% of fatty acids. The pH is 5.6, and more palatable than tomato juice.

This invention describes methods free from organic (chemical) solvents to produce a water soluble food ingredient high in lycopene (40000 ppm), which is stabilized by natural antioxidants (vitamin E, vitamin C), and beta-carotene.

It will be readily apparent to those skilled in the art that various changes and modifications of an obvious nature may be made without departing from the spirit of the invention, and all such changes and modifications are considered to fall within the scope of the invention as defined, by the appended claims. Such changes and modifications would include, but not be limited to, the incipient ingredients added to affect the capsule, tablet, lotion, food or bar manufacturing process as well as vitamins, herbs, flavorings and carriers. Other such changes or modifications would include the use of other herbs or botanical products containing the combinations of the preferred embodiments disclosed above. Many additional modifications and variations of the embodiments described herein may be made without departing from the scope, as is apparent to those skilled in the art. The specific embodiments described herein are offered by way of example only.

### EXAMPLES

The following examples are given to illustrate various embodiments which have been made or may be made in accordance with the present invention. These examples are given by way of examples only, and it is to be understood mat the following examples are not comprehensive or exhaustive of the many types of embodiments of the present invention which can be prepared in accordance with the present invention.

### Example 1

A red rice preparation rich in lycopene:

Ingredients

Mc powder (100 g)

1 1/2 cup coconut juice, rice milk, or milk, or coconut cream

1 cup Sushi rice (glutinous rice)

1 teaspoon sugar

Roasted sesame seeds

Homogenize mc powder in coconut juice for 30 sec. Mix juice and rice in a rice cooker, and cook per instruction. When rice is cooked, mix in sesame seeds and sugar. Can substitute sugar and sesame seeds with dried sweetened grated coconut (½ cups).

### Example 2

A yogurt composition

1 cut plain yogurt

100 g of mc powder

100 g of coconut water, mango juice, or pineapple juice

Desolve mc powder in juice, than blend with yogurt.

This composition contains 400 mg of lycopene

### Example 3

A high protein composition containing mc lycopene extract

Ingredients

150 mg stabilized Mc lycopene powder

500 mg Protein powder

Desolve in 1 cup of water or fruit juice or coconut water.

Depending on the solution, this composition provides >600 mg lycopene, >200 mg beta-carotene, >58 g complex carbohydrates, 343 calories, 5 I.U. vitamin E, >2 mg vitamin C and minerals

It will be readily apparent to those skilled in the art that various changes and modifications of an obvious nature may be made without departing from the spirit of the invention, and all such changes and modifications are considered to fall within the scope of the invention as defined by the appended claims. Such changes and modifications would include, but not be limited to, the incipient ingredients added to affect the capsule, tablet, lotion, food or bar manufacturing process as well as vitamins, herbs, flavorings and carriers. Other such changes or modifications would include the use of other herbs or botanical products containing the combinations of the preferred embodiments disclosed above. Many additional modifications and variations of the embodiments described herein may be made without departing from the scope, as is apparent to those skilled in the art. The specific embodiments described herein are offered by way of example only.

### REFERENCES

### US Patent Documents

| | | |
|---|---|---|
| 7,588,781 | Bortlik, et al. | Sep. 15, 2009 |
| 6,635,287 | Soudant, et al. | Oct. 21, 2003 |
| 7,511,078 | Yamamoto, et al. | Mar. 31, 2009 |
| 5,792,726, | Lorina et al., | Aug. 11, 1998 |
| 7,582,325 | Girori, Andrea | Jul. 14, 2005 |
| 5,837,311 | Morris, et al. | Nov. 17, 1998 |
| 8,017,147 | Mazed, et al. | Sep. 13, 2011 |
| 7,781,572 | Bartlett, et al. | Aug. 24, 2010 |
| 8,420,147 | Abelyan, et al. | Apr. 16, 2013 |
| 8,434,950 | Abelyan, et al. | Apr. 9, 2013 |
| 8,420,146 | Abelyan, et al. | Apr. 16, 2013 |
| 8,414,952 | Abelyan, et al. | Apr. 9, 2013 |
| 8,414,951 | Abelyan, et al. | Apr. 9, 2013 |
| 8,414,949 | Abelyan, et al. | Apr. 9, 2013 |
| 8,414,948 | Abelyan, et al. | Apr. 9, 2013 |
| 8,337,858 | Scoglio, et al. | Dec. 25, 2012 |
| 8,298,548 | Avila, et al. | Oct. 30, 2012 |
| 8,277,849 | Dillon, et al. | Oct. 2, 2012 |
| 8,246,961 | Arakawa, et al. | Aug. 21, 2012 |
| 8,075,929 | Shrikhande, et al. | Dec. 13, 2011 |
| 8,017,162 | Shimoda, et al. | Sep. 13, 2011 |
| 7,993,654 | Woeller, et al. | Aug. 9, 2011 |
| 7,867,545 | Friedman | Jan. 11, 2011 |
| 7,820,177 | Kruse et. al. | Oct. 26, 2010 |
| 7,767,235 | Shrikhande, et al. | Aug. 3, 2010 |
| 7,651,707 | Kappagoda | Jan. 26, 2010 |
| 7,588,781 | Bortlik | Sep. 15, 2009 |
| 7,348,034 | Murray, et al. | Mar. 25, 2008 |
| 7,186,422 | Jensen, et al. | Mar. 6, 2007 |
| 6,855,345 | Jensen, et al. | Feb. 15, 2005 |
| 6,632,449 | Nichoff | Oct. 14, 2003 |
| 6,506,427 | Garti, et al. | Jan. 14, 2003 |
| 4,851,339 | Hills | Jul. 25, 1989 |
| 3,172,770 | Miller | March 1965 |
| 5,245,095 | Graves, et al. | September 1993 |
| 5,274,073 | Gruber et al. | December 1993 |
| 5,462,695 | Tsai et al. | October 1995 |
| 5,686,489 | Yu et al. | November 1997 |
| 5,714,658 | Heidlas et al. | February 1998 |
| 5,773,075 | Todd | June 1998 |
| 5,789,647 | Heidlas et al. | August 1998 |
| 5,830,738 | Thomas et al. | November 1998 |
| 5,837,311 | Zelkha et al. | November 1998 |
| 5,871,574 | Kawaragi et al. | February 1999 |
| 5,897,866 | Bombardelli et al. | April 1999 |
| 6,818,239 | Kagan et al. | November 2004 |
| 2003/0052424 | Turner et al. | March 2003 |
| 2003/0061761 | Nanninga et al. | April 2003 |
| 2003/0180435 | Shi | September 2003 |
| 2004/0115260 | Schmid et al. | June 2004 |
| 2004/0131733 | Rey et al. | July 2004 |
| 2004/0208983 | Hill et al. | October 2004 |
| 7,572,468 | Ishida, et. al. | Aug. 11, 2009 |
| 2007/0212433 | Smidt et al. | September 2007 |
| 7,582,325 | Girori, Andrea | Jul. 14, 2005 |
| U.S. Pat. No. 5,837,311 | Morris, et al. | Nov. 17, 1998 |

European Patent Documents

| | | |
|---|---|---|
| CN102516011 (A) | Li | Jun. 27, 2012 |
| CN101978986 (A) | Kegang | Feb. 23, 2011 |
| CN101289364 (A) | Chen et al. | Oct. 22, 2008 |
| CN 101248861 (A) | Liu | Aug. 27, 2008 |
| WO03079816 (A1) | Girori | Oct. 2, 2003 |
| WO2006036125 (A1) | Ho Sue San | Apr. 6, 2006 |
| CA2305091 (A1) | Shi, et al. | May 5, 2001 |
| WO9748287 (A1) | Morris, et al. | Dec. 24, 1997 |
| CN101611878 (A) | Dayan, et al. | Dec. 30, 2009 |
| JPH1160980 (A) | Furuguchi, et al. | Mar. 5, 1999 |
| CN101697993(A); | Haijiang | Jul. 16, 2008 |
| JP2010001264 (A) | Takano et al. | Jan. 7, 2010 |
| JP2009040691 (A) | Takagaki et al. | Feb. 26, 2009 |
| JPH09328434 (A) | Kubo et al. | Dec. 22, 1997 |

### CITED REFERENCES

Ollanketo, M. et al., “Supercritical carbon dioxide extraction of lycopene in tomato skins,” Eur. Food Res. Technol. (2001) 212:561-565, 2001.

Periago, M. J. et al., “Mixture Approach for Optimizing Lycopene Extraction from Tomato and Tomato Products,” J. Agric. Food Chem. (2004) 52:5796-5802. cited by other.

Rozzi, N. L. et al., “Supercritical Fluid Extraction of Lycopene from Tomato Processing Byproducts,” J. Agric, Food Chem. (2002) 50:2638-2643. cited by other.

Christensen et al., Res Commun Chem Pathol Pharmacol., vol. 50 (1), pp. 147-150, 1985. cited by other.

http://web.archive.org/web/20030509095459/http://www.whfoods.org/genpage.p-hp?tname=foodspice&dbid=34. http://www.aaccnet.org/meeting/2001/Abstracts/a01ma154.htm.

Vuong, A method of preserving and testing the acceptability of gac fruit oil, a good source of beta-carotene and essential fatty acid, 2003, Food Nutr Bull, 24, 372-3. Solomon, in response to

Vuong and King, “A method of preserving and testing the acceptability og gac fruit oil, a good cource of beta-carotene and essential fatty acids,” 2003, Food, and Nutrition Bulletin, 24: 372-374.

Vuong and King, “A method of preserving and testing the acceptability og gac fruit oil, a good cource of beta-carotene and essential fatty acids;” 2003, Food and Nutrition Bulletin, 24: 224-230.

Le T, Vuong, Stephen R. Dueker, and Suzanne P Murphy, Plasma .beta.-carotene and retinol concentrations of children increase after a 30-d supplementation with the fruit Momordica cochinchinensis (gac). American Society for Clinical Nutrition. 2002. 872-9. cited by other.

Hiromitsu Aoki, Nguyen Thi Minh Kieu, Noriko Kuze, Kazue Tomisaka and Nguyen Van Chuyen, Carotenoid Pigments in GAC Fruit (Mamordica cochinchinensis Spreng), Biosci. Biotechnol. Biochem., 2002, 2479-2482, 66 (11).

Doug Burke, Genesis Juice, Feb. 1, 2005.

Pharmanex introduces G3 nutrition drink, scientifically shown to have high levels of antioxidants. Press Release [online], Pharmanex, Mar. 17, 2005 [retrieved on Oct. 11, 2007].

Internet: URL:http://www.pharmanex.com/corp/pharmanews/pressreleases/03-1-7-05.shtml.

Bailey L H. The Garden of the Gourds. New York: The Macmillian Company, 1937.

Baysal T., Ersus S., Starmans D. A J, Supercritical CO2 Extraction of˜-carotene and lycopene from tomato paste waste, J. Agric. Food Chem. 2000, 48, 5507-11.

Bendich, “Recent Advances in Clinical Research Involving Carotenoids,” Pure & Appi. Chem., vol. 66, No. 5, pp. 1017-1024 (1994).

Gartner C., Stahl W., Sies H., Lycopene is more bioavailable from tomato paste than from fresh tomatoes. Am J Clin Nutr 1997; 66:116-22, 1997.

Giovannucci et al., “Intake of Carotenoids and Retinol in Relation to Risk of Prostate Cancer,” J. of Nat l. Cancer Inst., vol. 87, No. 23, pp. 1767-1776 (1995). Heiser, Jr. The Gourd Book. Norman: University of Oklahoma Press, 1979.

Herklots G A C. Vegetables in South-East Asia. London: George Allen & Unwin LTD, 1972.

Khachik F. et ai. Effect of food preparation on qualitative and quantitative distribution of major carotenoid constituents of tomatoes and several green vegetables, J. Agric. Food Chem. 1992, 40, 390-8.

Mascia P, Kaiser S., Sies H., Lycopene as the Most Efficient Biological Carotenoid, Archives of Biochemistry and Biophysics, Vol. 274, No. 2, Nov 1, pp. 532-8, 1989. Levy et al., “Lycopene Is a More Potent Inhibitor of Human Cancer Cell Proliferation Than Either alpha-carotene, beta.-carotene,” Nutr. Cancer, vol. 24, pp. 257-266 (1995).

Le T. Vuong, Underutilized beta-carotene-rich crops of Vietnam. Food and Nutrition Bulletin, Vol. 21, No. 2, June 2000.

Narisawa et ai., “Inhibitory effects of natural carotenoids, .alpha.-carotene, .beta.carotene, lycopene and lutein, on colonic aberrant crypt foci formation in rats,” Cancer Letters, vol. 107, pp. 137-142 (1996).

Nguyen D V. Medicinal Plants of Vietnam, Cambodia and Laos, Westminster, Calif.: Mckong Printing, 1998.

Perry L. M. Medicinal Plants of East and Southeast Asia, Attributed Properties and Uses. Cambridge: The MIT Press, 1980.

Sadler G., Davis J., Dezman D. Rapid exraction of lycopene and—-carotene from reconstituted tomato paste and pink grapefruit homogentes. J. Food Sci. 1990, 55, 1460-Tan B, Analytical and preparative chromatography of tomato paste carotenoids. J. Food Sci. 1988, 53 (3), 954-59.

Conlon L E, King R D, Moran N E, Erdman J W Jr. Coconut Oil Enhances Tomato Carotenoid Tissue Accumulation Compared to Safflower Oil in the Mongolian Gerbil (Meriones unguiculatus).

What is claimed is:

1. Process to produce stable and bioavailable lycopene from momordica cochinchinensis Spreng (mc)

2. Process according to claim 1, comprises of selecting ripe, red mc fruit, either from fresh or frozen.

3. Process according to claim 1, comprises of de-seeding, pro-treating, freeze-drying, stabilizing and purifying without any organic solvent.

4. Process according to claim 1, wherein mc paste contains from 3500 to 7000 ppm of lycopene and 78% water

3. Process according to claim 2, wherein mc lycopene extract is stabilized with natural antioxidants including vitamin E and vitamin C

4. Process according to claim 3, wherein the stabilized mc pulp is pureed to produce a paste (mc paste)

5. Process according to claim 3, wherein stabilized mc paste is subject to freeze-dry process (lyophilized) moisture is reduced to 3-6%

6. Process according to claim 5, wherein lycopene concentration in freeze-dried powder is between 30000-50000 ppm, 77%-80% as trans-lycopene.

5. Process according to claim 1, wherein the separation of pulp from oil is carried out by cold press technique

6. Process according to claim 5, wherein de-oiled pulp is stabilized with at least one antioxidants from the group of vitamin E, vitamin C or polyphenol.

7. Process according to claim 6, wherein de-oiled pulp is subjected to pulverization, and drying until moisture is reduced to 5 ww %.

8. Process according to claim 7, wherein mc lycopene powder contains approximately 2300-5500 ppm of lycopene, with 80% is trans-lycopene.

9. Process according to claim 8, wherein mc lycopene powder is dispersed in whey protein to improve bioavailability

10. Process according to claim 9, wherein mc lycopene powder is re-suspense in edible fatty acids or oil to improve stability

11. Process according to claim 1, wherein the separation of pulp from water (serum) is carried out by centrifugation at temperatures between 60 degree and 700 degree C. and centrifugal force between 2600 and 4000 G.

12. Process according to claim 11, wherein the de-seeded pulp is reduced to have a content of solid particles between 4 and 8 ww %.

13. Process according to claim 12, wherein the mc pulp is subjected to separation to have a content of solid particles, having a dimension below 20 .mu.m, of less than 0.2 ww %.

14. Process according to claim 1, wherein stability is improved by mixing mc lycopene extract with at least one protein from grain such as soy, rice, whey protein, or vegetable protein.

15. Process according to claim 1, whereby stability is improved by mixing mc lycopene with at least one or more carbohydrates

16. The process according to claim 1, wherein stability and bioavailability of mc lycopene extract is improved by combining at least an antioxidant plant extract from the group, grape juice, orange juice with an effective amount of mc lycopene extract

17. The method in claim 16 wherein the antioxidant component, lycopene and other nutrients are administered as a single composition

18. The method in claim 17 wherein mc lycopene extract comprises from 5 to 40 wt % of total weight of the composition

19. The method in claim 17 wherein mc lycopene extract component comprises from 15 to 20% of total weight of the composition

20. The method in claim 16 wherein the other plant antioxidant extract might be selected from the group consisting of pineapple, mango, dragon fruit, lychi, melon, apple, passion fruit, coconut water or a mixture thereof

21. The method in claim 16 wherein mc lycopene extract comprise of 20-50 wt % of total carotenoids

22. The method in claim 16 wherein the nutritional composition contains vitamin C (2-30 wt %), a natural preservative

23. The method of claim 16 wherein the nutritional composition includes excipients selected from the group consisting of flavorants, colorants, stabilizers and preservatives

24. The method in claim 16 wherein the lycopene absorption is increased by at least 15 to 50% as compared to an equivalent total lycopene dosage that does not include mc lycopene extract

25. The method in claim 16 wherein the mc lycopene extract might be contained in a carrier oil

26. The method in claim 25 wherein the carrier oil might be selected from a member of edible oil such as gac fruit oil, olive oil, safflower oil, corn oil, fish oil

27. The method in claim 1 wherein the carrier oil may be 1 to 98 wt. % of the total wt of the product

28. The method in claim 1 wherein the carrier oil also contains vitamin E, a natural preservative, of at least of 2-5 wt %

29. The method in claim 6 wherein the mc lycopene components, whey protein and other nutrients are administered as a single composition

30. The method in claim 5 wherein mc lycopene component comprises from 10 to 40 wt % of total weight of the composition

31. The method in claim 5 wherein >50% of total carotenoids are lycopene carotenoids

32. The method in claim 5 wherein the carotenoids containing plant extract comprise of at least 60% of the total fatty acid concentration

33. The method in claim 6 wherein lycopene carotenoids comprise of 60-80 wt % of total carotenoids

34. The method in claim 13 wherein the other ingredient might be artificial or natural flavor, or extract, or puree, or concentrate, or juice selected from the group of pineapple, mango, dragon fruit, lychi, melon, apple, passion fruit or a mixture thereof

35. The method in claim 13 wherein the nutritional composition contains vitamin C (2-30 wt %), a natural preservative

36. The method of claim 4 wherein the nutritional composition includes excipients selected from the group consisting of flavorants, colorants, stabilizers and preservatives

37. An oral dosage composition for delivering lycopene carotenoids to a subject comprising: at least one carotenoid and a carotenoid bioavailability enhancing amount of gac fruit extract

38. The oral dosage composition of claim 17, wherein the gac fruit extract comprises from 5 to about 20 wt % of the composition

39. The oral dosage composition of claim 18 wherein the gac fruit extract comprises from 10% to 15% of the composition

40. The oral dosage compostion of claim 19 wherein the at least one lycopene carotenoid is present as part of at least one plant extract.
